(19) United States
(12) Patent Application Publication
(10) Pub. No.: US 2011/0258682 A1
(43) Pub. Date: Oct. 20, 2011

(54) METHOD, APPARATUS, AND SYSTEM FOR PROCESSING SESSION CONTEXT

(76) Inventor: Yu YIN, Shanghai (CN)

(21) Appl. No.: 13/173,212

(22) Filed: Jun. 30, 2011

Related U.S. Application Data
(63) Continuation of application No. PCT/CN2009/073064, filed on Aug. 4, 2009.

(30) Foreign Application Priority Data
Dec. 31, 2008 (CN) 200810247430.8

(51) Int. Cl. G06F 21/20; G06F 21/00

(52) U.S. Cl. 726/3; 726/22

(57) ABSTRACT

A method, an apparatus, and a system for processing session context are disclosed. The method for processing session context includes: receiving a reset notification message that carries a device identifier; confirming that a reset event corresponding to the reset notification message occurs on a peer device identified by the device identifier; and deleting an associated context related to the reset event. According to the present invention, after a local device receives a reset notification message from a peer device and before deleting an associated context related to the reset event of the peer device, the local device needs to confirm the authenticity of the reset notification message with the peer device. In this way, the associated context on the device will not be wrongly deleted due to the attack from a fake source address, and it is ensured that the associated context are correctly processed after a reset notification message is received, thus ensuring that the local device can perform normal communication and improving the system security.

### CROSS-REFERENCE TO RELATED APPLICATIONS

This application is a continuation of International Application No. PCT/CN2009/073064, filed on Aug. 4, 2009, which claims priority to Chinese Patent Application No. 200810247430.8, filed on Dec. 31, 2008, both of which are hereby incorporated by reference in their entireties.

### FIELD OF THE INVENTION

The present invention relates to the field of communication technologies, and in particular, to a method, an apparatus, and a system for processing session context.

### BACKGROUND OF THE INVENTION

To establish a data transmission channel between multiple devices in a communication network system, a context generally needs to be created for the data transmission channel on each device. When data of the control plane or the user plane is transferred between the devices, the data carries an identifier of a corresponding context on the destination device; after receiving the data, the destination device searches for the corresponding context according to the identifier of the context, and determines subsequent processing according to the parameters in the context, for example, forwarding, quality of service (QoS) control, and charging.

Session context created for the same session on different devices is called associated context. If a session context on one device is deleted due to the fault of the device or a processing exception, the associated context on other device become junk context and need to be deleted. When all or some modules on the device fail, a large quantity of associated context on other devices may be affected. In the prior art, a complete reset notification or a partial reset notification may be used to instruct other devices to delete the associated context.

In the complete reset notification process and partial reset notification process in the prior art, attackers may initiate attacks by faking a source address, that is, use the (complete or partial) reset notification message by faking the source address. Attackers may fake a (complete or partial) reset notification message by using the identifier of an obtained legal device node, for example, the IP address of the node, and send the fake (complete or partial) reset notification message to other device nodes; after receiving the fake reset notification, other device nodes may wrongly believe that the fake (complete or partial) reset notification message is sent from a legal device node, and delete all or part of the session contexts according to the fake reset notification message. Consequently, a large quantity of session contexts are wrongly deleted, and the devices cannot perform normal communication.

### SUMMARY OF THE INVENTION

Embodiments of the present invention provide a method, an apparatus, and a system for processing session context to avoid wrongly deleting associated context on device and ensure that the associated context is correctly processed after a reset notification message is received, thus ensuring normal communication between the devices and improving the system security.

An embodiment of the present invention provides a method for processing session context, including:

receiving a reset notification message that carries a device identifier;

confirming that a reset event corresponding to the reset notification message occurs on a peer device identified by the device identifier; and

deleting an associated context related to the reset event.

An embodiment of the present invention provides an apparatus for processing session context, including:

a receiving module, configured to receive a reset notification message that carries a device identifier;

a confirming module, configured to confirm that a reset event corresponding to the reset notification message occurs on a peer device identified by the device identifier; and

a processing module, configured to delete an associated context related to the reset event.

An embodiment of the present invention provides a system for processing session context, including a peer device and a local device.

The peer device is configured to send a reset notification message that carries a device identifier to the local device after a reset event occurs.

The local device is configured to: receive the reset notification message that carries the device identifier, confirm that the reset event corresponding to the reset notification message occurs on the peer device identified by the device identifier, and delete an associated context related to the reset event.

According to the preceding technical solution provided in the embodiments of the present invention, after the local device receives a reset notification message from the peer device and before deleting the associated context related to the reset event of the peer device on the local device, the local device needs to confirm the authenticity of the reset notification message with the peer device. In this way, the associated context on the local device will not be wrongly deleted, and it is ensured that the associated context is correctly processed after a reset notification message is received, thus ensuring that the local device can perform normal communication and improving the system security.

### BRIEF DESCRIPTION OF THE DRAWINGS

To illustrate the technical solution in the embodiments of the present invention or in the prior art more clearly, the accompanying drawings for describing the embodiments or the prior art are outlined below. Apparently, the accompanying drawings in the following description are only some embodiments of the present invention, and persons of ordinary skill in the art can derive other drawings from the accompanying drawings without creative efforts.

FIG. 1 is a schematic flowchart of a method for processing session context according to a first embodiment of the present invention;

FIG. 2 is a schematic flowchart of a method for processing session context according to a second embodiment of the present invention;

FIG. 3 is a schematic flowchart of a method for processing session context according to a third embodiment of the present invention;

FIG. 4 is a schematic structural diagram of an apparatus for processing session context according to a fourth embodiment of the present invention;

FIG. 5 is a schematic structural diagram of an apparatus for processing session context according to a fifth embodiment of the present invention;

FIG. 6 is a schematic structural diagram of an apparatus for processing session context according to a sixth embodiment of the present invention; and

FIG. 7 is a schematic structural diagram of a system for processing session context according to a seventh embodiment of the present invention.

### DETAILED DESCRIPTION OF THE EMBODIMENTS

The technical solution of the present invention is hereinafter described in detail with reference to the embodiments and accompanying drawings. It is evident that the embodiments are exemplary only and the present invention is not limited to such embodiments. Those of ordinary skill in the art can derive other embodiments from the embodiments given herein without creative efforts, and all such embodiments are covered in the protection scope of the present invention.

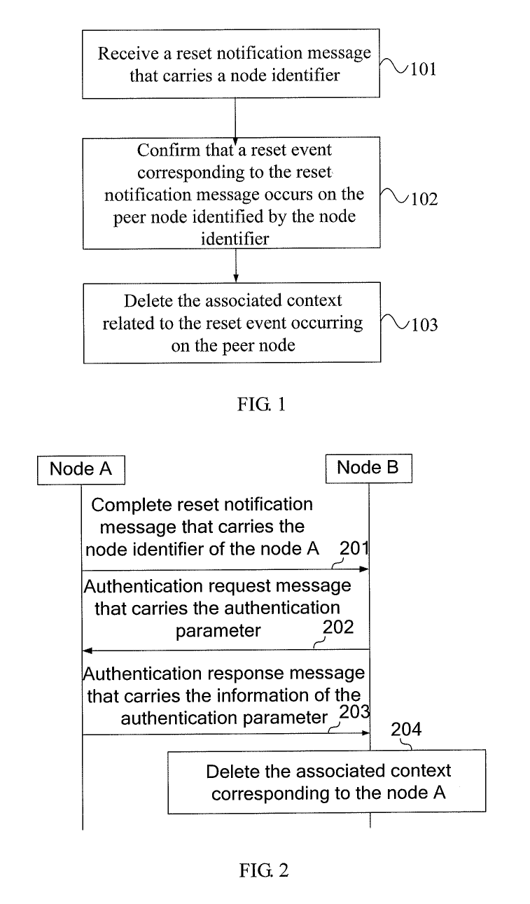

FIG. 1 is a schematic flowchart of a method for processing session context according to the first embodiment of the present invention. As shown in FIG. 1, the method includes the following steps:

Step 101: Receive a reset notification message that carries a device identifier.

Step 102: Confirm that a reset event corresponding to the reset notification message occurs on a peer device identified by the device identifier.

Step 103: Delete the associated context related to the reset event occurring on the peer device.

The reset notification message may be a complete reset notification message or a partial reset notification message.

In this embodiment, after the local device receives a reset notification message from the peer device and before deleting the associated context related to the reset event of the peer device on the local device, the local device needs to confirm the authenticity of the reset notification message with the peer device. In this way, the associated context on the device will not be wrongly deleted due to the attack from a fake source address, and it is ensured that the associated context is correctly processed after a reset notification message is received, thus ensuring that the local device can perform normal communication. In this embodiment, it is more difficult to attack the device through a fake reset notification message based on a fake source address, and the risk of initiating a reset notification attack by faking the source address is lowered, thus improving the system security.

FIG. 2 is a schematic flowchart of a method for processing session context according to the second embodiment of the present invention. As shown in FIG. 2, the method includes the following steps:

Step 201: The local device (that is, device B) receives a complete reset notification message that carries the device identifier of the peer device (that is, device A).

The complete reset notification message in this embodiment may be an independent message. After receiving a complete reset notification message that is used as an independent message, the local device initially judges that a complete reset (restart) event occurs on the peer device.

Optionally, the complete reset notification message in this embodiment may also be another existing message and is not specially used to notify the occurrence of a complete reset event. For example, a restart count information element may be further carried in messages like a create session request (Create Session Request) message or an echo request (Echo Request) message that are in the GPRS Tunneling Protocol (GPRS tunneling protocol, briefly referred to as GTP) to notify a peer device (corresponding to above device B) that a complete reset event occurs on the local device (corresponding to device A). The peer device (corresponding to above device B) judges whether a complete reset (restart) event occurs on the local device (corresponding to device A) by comparing the restart count of the local device (corresponding to device A) carried in the received message with the stored original restart count of the local device (corresponding to device A).

The device identifier of device A may be the IP address of device A, that is, the source address of the complete reset notification message is the IP address of device A.

Step 202: After being notified of the fact that the complete reset (restart) event occurs on device A, device B sends an authentication request message (for example, a GTP echo request message) that carries an authentication parameter to device A.

In this step, when the echo request is used as the authentication request message, the authentication parameter may directly use the sequence number of the GTP header, which is allocated by device B of the sender and set in the GTP header of the echo request message. Optionally, the authentication parameter in this embodiment may also be an additional authentication parameter in any forms besides the sequence number. If the original restart count of device A is not stored on device B, this step also needs to be executed before the latest restart count of device A carried in the message in step 201 is stored. If the latest restart count of device A carried in the message in step 201 is the same as the original restart count of device A stored on device B, device B does not send the authentication request message and does not perform subsequent processing.

Step 203: Device A receives the authentication request message, and sends an authentication response message to device B according to a preset processing policy. For example, device A sends a GTP echo response (Echo Response) message that carries the information of the preceding authentication parameter and the current restart count of device A.

In this step, device A returns the sequence number of the GTP header in the echo response message to device B. According to the GTP specifications, the sequence number should be filled as the sequence number of the GTP header in the corresponding echo request message. Therefore, if device B receives the echo response message returned by device A and the sequence number in the echo response message matches the sequence number in the echo request message, it indicates that the echo response message is really sent from device A.

If the authentication request message that device B sends to device A carries other additional authentication parameters besides the sequence number in the GTP header, device A may carry the additional authentication parameters in the authentication response message when returning the authentication response message, or transform the preceding additional authentication parameters into transformed authentication parameters by using a preset transforming algorithm negotiated between device A and device B and carry the transformed authentication parameters in the authentication response message. The transforming algorithm may perform encryption or hash (Hash) operation by using a key negotiated (automatically or manually) between device A and device B. If the complete reset notification message in step 201 is really sent from device A, the current restart count of device A in this step should be the same as the restart count in step 201.

Optionally, in step 202, device B may not send the authentication parameter to device A through the authentication request message, but configure the authentication parameter in advance on device A through negotiation with device A. Also, when device A returns an authentication response message, device A should carry the information of the set authentication parameter in the authentication response message.

Step 204: Device B receives the authentication response message. Because it can be believed, according to the information of the authentication parameter carried in the authentication response message, that the authentication response is really sent from device A, the current restart count of device A carried in the authentication response message is trustable. Device B compares the current restart count of device A carried in the authentication response message with the stored original restart count; if the two restart counts are different, device B confirms that a complete reset event occurs on the peer device, and then deletes the associated context corresponding to device A.

In this step, after device B receives the authentication response message, device B compares the current restart count of device A carried in the authentication response message with the stored original restart count of device A; if the two restart counts are different, it indicates that the restart count is really changed. In this case, device B confirms that a complete reset event occurs on device A, and starts cleaning the junk context to delete the associated context related to device A. Device B further stores the current restart count of device A carried in the authentication response message as the latest restart count of device A; if the two restart counts are the same, it indicates that the restart count of device A is not changed, that is, the complete reset notification message received by device B is fake, and that the restart count carried in the complete reset notification message is not the latest restart count of device A. In this case, device A ignores the complete reset notification message, and may not start cleaning the junk context.

In this embodiment, because the information of the authentication parameter carried in the authentication response message in step 203 needs to match the authentication parameter carried in the authentication request message in step 202, after the method for processing session context in this embodiment is applied, an attacker should be able to capture the authentication request message that device B sends to device A to obtain the authentication parameter carried in the authentication request message so as to perform an attack successfully. This imposes higher requirements on the attacker. The attacker may fake the IP address of device A as the source address at the network position where the attacker initiates the attack, and send a complete reset notification message to device B successfully. However, it cannot be ensured that the attacker can capture a message whose destination address is the IP address of device A. In addition, the authentication request in step 202 is generally amidst a large quantity of data streams. Therefore, the operation load may be heavy if the attacker wants to filter the authentication request in step 202 from a large quantity of data within a very short time (before the real device A returns an authentication response message normally). Therefore, after the method for processing session context in this embodiment is applied, the position where the attacker can initiate the attack is greatly narrowed, and the difficulty of the attack is greatly increased.

It should be noted that if the message carrying the latest restart count of device A in step 201 is a response message, for example, a create session response (Create Session Response) message, and an echo response (Echo Response) message that are in GTP. The information of the authentication parameter carried in the preceding response message must be the same as the authentication parameter that device B allocates to the corresponding request, and this achieves the authentication effect in step 202 and step 203. Therefore, if the current restart count of device A carried in the received response is different from the stored original restart count of device A, the authentication process in step 202 and step 203 may be omitted. In fact, in this embodiment, the complete reset notification message that the peer device sends initiatively is not trusted. After a complete reset notification that the peer device sends initiatively is received, the interactive authentication with the peer device is triggered to confirm the authenticity of the complete reset event message.

Further, to make it more difficult to perform the attack, device A may carry the latest restart count of device B or other identifier information pre-generated by device B in the message in step 201 or step 203 to verify that the peer device that previously sends the complete reset notification message already receives the authentication request message from the local device. It should be noted that if device A is required to carry the latest restart count value of device B or other identifier information pre-generated by device B in step 201, the authentication processes in step 202 and step 203 may also be skipped, and the process goes to step 204 directly. That is, in this case, the step of performing active authentication is optional.

In this embodiment, after receiving the complete reset notification message from device A and before starting the scanning and cleaning of the junk context, device B sends an authentication request message to device A to check whether the restart count of device A is really changed. After receiving an acknowledgment (ACK) from device A, device B starts the scanning and cleaning of the junk context.

Further, a valid time range may be set for the authentication parameter that device B sends to device A in step 202. That is, the authentication parameter is valid only when it is returned from device A to device B within a time range (for example, 10 seconds). After the time range expires, device B may directly discard the received authentication response message, and will not initiate a step of deleting the associated context related to device A. During the specific implementation, device B may start a timer after sending an authentication request message carrying the authentication parameter to device A to wait for the authentication response returned from device A. Device B may also use the local time stamp information when device B sends an authentication request message to device A as part of the authentication parameter. After receiving the authentication response from device A, device B compares the time stamp information in the authentication parameter carried in the authentication response message with the current local time, and decides whether to delete the associated context related to device A according to whether the difference between the time stamp information and the current local time is within the valid time range.

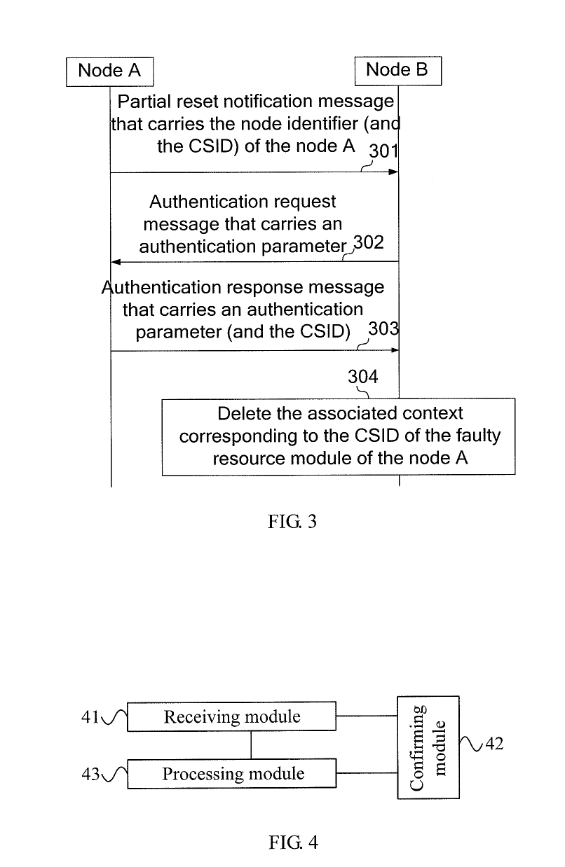

When the entire device is not faulty but only some modules (for example, boards) inside the device are faulty, only some associated context related to the faulty module need to be deleted. It is understandable that a device generally has multiple different resource modules with different functions and a session context inside the device is created on a resource combination consisting of multiple resource modules. Therefore, the case may be more complicated. In this embodiment, for simple description, it is assumed that only one type of resource is available inside the device, that is, the resource modules inside the device have the same function. This assumption does not affect the description of the solution of the present invention. For example, device A consists of N resource modules (such as boards) with the same function. Device A may choose to create a session context on any resource module. Device A allocates a packet data network (PDN) connection set identifier (CSID) to each resource module (the combination of resource modules when there are resource modules with different functions). During the process of creating a session, if a local device, for example, device A, chooses to create a session context on a resource module, device A may carry the CSID corresponding to the resource module in a Create Session message sent to a peer device, for example, device B. Similarly, device B may also choose to create a session context on a resource module, store the CSID that device A allocates to the session in the session context, and return the CSID corresponding to the chosen resource module on which the session context is created to device A; device A may also store the CSID that device B allocates to the session in the session context. FIG. 3 is a schematic flowchart of a method for processing session context according to the third embodiment of the present invention. As shown in FIG. 3, the method includes the following steps:

Step 301: The local device (that is, device B) receives a partial reset notification message that carries the device identifier and a CSID of the peer device (that is, device A).

The partial reset notification message in this embodiment may be an independent message, for example, a Delete Public Data Network Connection Set Request in GTP, which is used to notify the local device (corresponding to above device B) that a partial reset event occurs on the peer device(corresponding to above device A). After receiving the partial reset notification used as an independent message, the local device (corresponding to above device B) initially judges that a partial reset (restart) event occurs on the peer device (corresponding to above device A).

Optionally, the partial reset notification message in this embodiment may also be an existing message in other protocol messages, and is not specially used to notify the occurrence of the partial reset event.

The device identifier of device A may be the IP address of device A, that is, the source address of the partial reset notification message is the IP address of device A. Supposing a certain number of associated sessions are created earlier between device A and device B, in the process of creating a session, the CSID allocated to the session is exchanged between device A and device B, and the CSID that the peer device allocates to the session is stored in the session context inside the device. When some resource modules of device A are faulty, device A sends a partial reset notification message to device B, where the partial reset notification message may further carry CSIDs corresponding to the faulty resource modules of device A to notify the local device of the faulty resource modules.

Step 302: After device B is notified of the fact that the partial reset (restart) event occurs on device A, device B sends an authentication request message that carries an authentication parameter (for example, the Delete PDN Connection Set Response in GTP) to device A. The cause in the Delete PDN Connection Set Response is set to “Authentication Required”.

The authentication parameter may be designed in any forms. For example, an authentication word allocated by device B may be a 64-bit authentication parameter.

Step 303: Device A receives the authentication request message, and sends an authentication response message to device B according to a preset processing policy. For example, device A resends the Delete PDN Connection Set Request. Different from the message in step 301, the authentication response further carries the information of the authentication parameter that device B sends to device A and which is used to authenticate the partial reset authenticity in step 302. If the partial reset notification in step 301 does not carry the CSIDs corresponding to the faulty resource modules of device A, the authentication response message in this step should also carry the CSIDs corresponding to the faulty resource modules of device A to notify the local device of the faulty resource modules.

In this step, the information of the authentication parameter carried in the preceding authentication response message may be the original authentication parameter carried in the authentication request message, or a converted authentication parameter that is obtained through the conversion of the original authentication parameter by using a conversion algorithm negotiated between device A and device B. The method for converting the authentication parameter may include performing encryption or hash (Hash) operation on the key negotiated (automatically or manually) between device A and device B.

Optionally, in step 302, device B may not send the authentication parameter to device A through the authentication request message, but configure the authentication parameter earlier on device A through negotiation with device A. Similarly, when device A returns an authentication response message, device A should carry the information of the authentication parameter in the authentication response message.

Step 304: Device B receives the authentication response message, and confirms that the received partial reset notification message is really sent from device A according to the information of the authentication parameter carried in the authentication response. In this case, device B may confirm that a partial reset event occurs on the peer device, and then delete the associated context corresponding to the CSID of the faulty resource module of device A.

In this embodiment, because the information of the authentication parameter carried in the authentication response message in step 303 must match the authentication parameter carried in the authentication request in step 302, after the method for processing session context in this embodiment is applied, to perform an attack successfully, an attacker must be able to capture the authentication request message that device B sends to device A in step 302 to obtain the authentication parameter carried in the authentication request message. This imposes higher requirements on the attacker. The attacker may fake the IP address of device A as the source address at the network position where the attacker initiates the attack, and send a partial reset notification message to device B successfully. However, it cannot be ensured that the attacker can capture a message whose destination address is the IP address of device A. In addition, the authentication request message in step 302 is generally amidst a large quantity of data streams. Therefore, the operation load may be large if the attacker wants to filter the authentication request message in step 302 from a large quantity of data within a very short time (before the real device A returns an authentication response message normally). Therefore, after the method for processing session context in this embodiment is applied, the position where the attacker can initiate the attack is greatly narrowed, and the difficulty of the attack is greatly increased.

Similar to the message described in the preceding embodiment, the message received by device B in step 301 may also be a Delete Public Data Network Connection Set Request in GTP, which carries the information of the authentication parameter that device B sends to device A and is used to authenticate the partial reset authenticity. This achieves the authentication effect in step 302 and step 303. Therefore, the authentication processes in step 302 and step 303 may be omitted. In this embodiment, the partial reset notification message that the peer device sends initiatively is not trusted. After a partial reset notification message that the peer device sends initiatively is received, the interactive authentication with the peer device is triggered to confirm the authenticity of the partial reset event.

Further, to make it more difficult to perform the attack, device A may carry the latest restart count of device B or other identifier information pre-generated by device B in the message in step 301 or step 303 to verify that the peer device that previously sends the partial reset notification message already receives the authentication request from the local device. It should be noted that if device A is required to carry the latest restart count value of device B or other identifier information pre-generated by device B in step 301, the authentication processes in step 302 and step 303 may also be skipped, and the process goes to step 304 directly. That is, in this case, the step of performing active authentication is optional.

In this embodiment, after receiving the partial reset notification message from device A and before starting the scanning and cleaning of junk context, device B sends an authentication request message to device A to check whether part of the resource modules of device A are really faulty. After receiving an ACK from device A, device B starts the scanning and cleaning of the junk context corresponding to the CSID.

Further, a valid time range may be set for the authentication parameter that device B sends to device A in step 302. The specific implementation is the same as that of the preceding embodiment, and is not further described.

FIG. 4 is a schematic structural diagram of an apparatus for processing session context according to the fourth embodiment of the present invention. As shown in FIG. 4, the apparatus may include a receiving module 41, a confirming module 42, and a processing module 43. The receiving module 41 is configured to receive a reset notification message that carries a device identifier. The confirming module 42 is configured to confirm that a reset event corresponding to the reset notification message occurs on the peer device identified by the device identifier. The processing module 43 is configured to delete the associated context related to the reset event of the peer device.

The reset notification received by the receiving module 41 may be a complete reset notification message or a partial notification message. The confirming module 42 may also confirm the authenticity of the reset notification message received by the receiving module 41 with the peer device by obtaining an authentication parameter allocated by the peer device. The authentication parameter may be sent to the peer device by the local device through an authentication message or pre-configured on the peer device.

In this embodiment, the receiving module receives a reset notification message from the peer device; before the processing module deletes the associated context related to the reset event of the peer device, the confirming module needs to confirm the authenticity of the preceding reset notification message with the peer device. In this way, the associated context on the device will not be wrongly deleted due to the attack from a fake source address, and it is ensured that the associated context is correctly processed after a reset notification message is received, thus ensuring that the local device can perform normal communication. In this embodiment, it is more difficult to attack the device by using a reset notification message based on a fake source address, and the risk of initiating a reset notification attack by faking the source address is lowered, thus improving the system security.

The functions of device B provided in the second embodiment and the third embodiment may be implemented by the apparatus for processing session context in this embodiment.

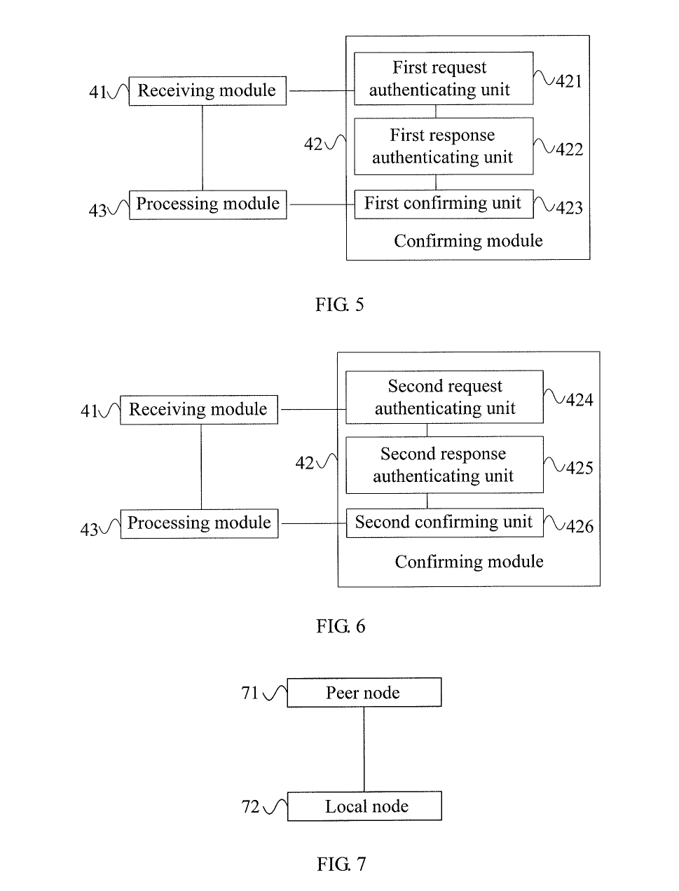

FIG. 5 is a schematic structural diagram of an apparatus for processing session context according to the fifth embodiment of the present invention. As shown in FIG. 5, the confirming module of the apparatus for processing session context in this embodiment may confirm that the reset notification message is sent from the peer device through interactive authentication with the peer device. Accordingly, the confirming module 42 provided in this embodiment may further include a first request authenticating unit 421, a first response authenticating unit 422, and a first confirming unit 423. The first request authenticating unit 421 sends an authentication request that carries an authentication parameter to the peer device. The first response authenticating unit 422 receives an authentication response message that the peer device returns according to the authentication request message, where the authentication response message carries the information of the preceding authentication parameter. The first confirming unit 423 confirms that the preceding reset event occurs on the peer device according to the information of the preceding authentication parameter.

In this embodiment, after the receiving module receives the reset notification message from the peer device and before the processing module starts the scanning and cleaning of the junk context, the first request authenticating unit of the confirming module sends an authentication request message that carries the authentication parameter to the peer device to check whether a reset (restart) event really occurs on the peer device; after the first response authenticating unit receives an authentication response message that carries the information of the preceding authentication parameter from the peer device, the first confirming unit confirms that the reset notification message received by the receiving module is sent from the peer device so as to trigger the processing module to start the scanning and cleaning of the junk context.

FIG. 6 is a schematic structure diagram of an apparatus for processing session context according to the sixth embodiment of the present invention. As shown in FIG. 6, the authentication parameter obtained by the peer device in this embodiment may also be set earlier on the peer device through negotiation message between the local device and the peer device. The confirming module 42 in this embodiment may further include a second request authenticating unit 424, a second response authenticating unit 425, and a second confirming unit 426. The second request authenticating unit 424 sends an authentication request message to the peer device. The second response authenticating unit 425 receives an authentication response message that the peer device returns according to the authentication request message, where the authentication response message carries the information of the preceding authentication parameter that is configured earlier on the peer device. The second confirming unit 426 confirms that the preceding reset event occurs on the peer device according to the information of the preceding authentication parameter.

In this embodiment, after the receiving module receives the reset notification message from the peer device and before the processing module starts the scanning and cleaning of the junk context, the second request authenticating unit of the confirming module sends an authentication request message to the peer device to check whether a reset (restart) event really occurs on the peer device; after the second response authenticating unit receives an authentication response message that carries the information of the preceding authentication parameter configured earlier on the peer device from the peer device, the second confirming unit may confirm that the reset notification message received by the receiving module is sent from the peer device so as to trigger the processing module to start the scanning and cleaning of the junk context.

Further, the reset notification message received by the receiving module in this embodiment may further carry the information of the authentication parameter. Specifically, the confirming module may confirm that the reset event occurs on the peer device according to the information of the authentication parameter.

FIG. 7 is a schematic structural diagram of a system for processing session context according to the seventh embodiment of the present invention. As shown in FIG. 7, the system for processing session context in this embodiment may include a peer device 71 and a local device 72.

The peer device 71 is configured to send a reset notification message that carries a device identifier to the local device 72 after a reset event occurs.

The local device 72 is configured to: receive the reset notification message that carries the device identifier, confirm that the reset event corresponding to the reset notification message occurs on the peer device 71 identified by the device identifier, and delete an associated context related to the reset event.

The method provided in the first embodiment and the functions of device B provided in the second embodiment and third embodiment of the present invention are implemented by the local device 72 in the system for processing session context provided in this embodiment.

In this embodiment, after the local device receives a reset notification message from the peer device and before deleting the associated context related to the reset event of the peer device, the local device needs to confirm the authenticity of the reset notification message with the peer device. In this way, the associated context on the device will not be wrongly deleted due to the attack from a fake source address, and it is ensured that the associated context is correctly processed after a reset notification message is received, thus ensuring that the local device can perform normal communication. In this embodiment, it is more difficult to attack the device by using a reset notification message based on a fake source address, and the risk of initiating a reset notification attack by faking the source address is lowered, thus improving the system security.

The preceding embodiments of the present invention are not limited to the applied network system. GTP is only an example provided in this embodiment. The ideal of the present invention may also be applied in other protocol messages, for example, Proxy Mobile IPv6 (PMIPv6). The complete reset notification message may be a heartbeat message that carries a restart count. The receiving device may also verify the authenticity of the complete reset event of the peer device by sending a heartbeat request and receiving a heartbeat response from the peer device. Similarly, in PMIPv6, the partial reset notification message may be a Binding Revocation Indication (Binding Revocation Indication) message that carries a CSID option, and the receiving device may verify the authenticity of the partial reset event of the peer device by returning a Binding Revocation Acknowledgement (Binding Revocation Acknowledgement) message that carries a special cause (for example, “Authentication Required”) and an authentication parameter and requiring the peer device to resend the Binding Revocation Indication that carries the authentication parameter.

It is understandable that the message names provided in the embodiments of the present invention are only used to better describe the technical solution of the present invention. During the specific implementation, any message may be added, or information elements may be added to the existing messages.

Those of ordinary skill in the art may understand that all or part of the steps of the method according to the embodiments of the present invention may be implemented by a program instructing relevant hardware. The program may be stored in a computer readable storage medium. When the program runs, the steps of the method according to the embodiments of the present invention are performed. The storage medium may be a read only memory (ROM), a random access memory (RAM), a magnetic disk, or a compact disk-read only memory (CD-ROM).

It should be noted that the preceding embodiments are merely provided for describing the technical solution of the present invention, but not intended to limit the present invention. Although the present invention has been described in detail with reference to the foregoing embodiments, it is apparent that those of ordinary skill in the art can make various modifications and variations to the invention without departing from the spirit and scope of the invention. The invention shall cover the modifications and variations provided that they fall within the scope of protection defined by the following claims or their equivalents.

What is claimed is:

1. A method for processing session context, comprising:
receiving a reset notification message that carries a device identifier;
confirming that a reset event corresponding to the reset notification message occurs on a peer device identified by the device identifier; and
deleting an associated context related to the reset event.

2. The method of claim 1, wherein the reset notification message comprises one of a complete reset notification message and a partial reset notification message.

3. The method of claim 2, wherein the step of confirming that the reset event corresponding to the reset notification message occurs on the peer device identified by the device identifier comprises: performing interactive authentication with the peer device and confirming that the reset event occurs on the peer device.

4. The method of claim 3, wherein the step of performing interactive authentication on the peer device and confirming that the reset event occurs on the peer device comprises:
sending an authentication request message that carries an authentication parameter to the peer device;
receiving an authentication response message that the peer device returns according to the authentication request message, wherein the authentication response message carries information of the authentication parameter; and
confirming that the reset event occurs on the peer device according to the information of the authentication parameter.

5. The method of claim 3, wherein the step of performing interactive authentication on the peer device and confirming that the reset event occurs on the peer device comprises:
sending an authentication request message to the peer device;
receiving an authentication response message that the peer device returns according to the authentication request message, wherein the authentication response message carries information of an authentication parameter; and
confirming that the reset event occurs on the peer device according to the information of the authentication parameter.

6. The method of claim 4, wherein the information of the authentication parameter comprises at least one of the authentication parameter and a converted authentication parameter obtained after the authentication parameter is converted.

7. The method of claim 5, wherein the information of the authentication parameter comprises at least one of the authentication parameter and a converted authentication parameter obtained after the authentication parameter is converted.

8. The method of claim 6, wherein the authentication parameter comprises one of a current restart count of a local device and identifier information pre-generated by a peer device.

9. The method of claim 8, wherein the authentication parameter comprises one of a current restart count of a local device and identifier information pre-generated by a peer device.

10. The method of claim 4, wherein the step of confirming that the reset event occurs on the peer device according to the authentication parameter comprises: if receiving the authentication response message within a valid time period, confirming, according to the information of the authentication parameter, that the reset event occurs on the peer device.

11. The method of claim 5, wherein the step of confirming that the reset event occurs on the peer device according to the authentication parameter comprises: if receiving the authentication response message within a valid time period, confirming, according to the information of the authentication parameter, that the reset event occurs on the peer device.

12. The method of claim 10, wherein the authentication parameter comprises at least one of time when the reset notification message is received and time when the authentication response message is expected to be received.

13. The method of claim 11, wherein the authentication parameter comprises at least one of time when the reset notification message is received and time when the authentication response message is expected to be received.

14. The method of claim 2, wherein the reset notification message further carries information of an authentication parameter, and the step of confirming that the reset event corresponding to the reset notification message occurs on the peer device identified by the device identifier comprises: confirming, according to the information of the authentication parameter, that the reset event occurs on the peer device.

15. The method of claim 4, wherein the partial reset notification message further carries a packet data network (PDN) connection set identifier (CSID), and the step of deleting the associated context related to the reset event comprises: deleting an associated context corresponding to the CSID.

16. An apparatus for processing session context, comprising:
a receiving module, configured to receive a reset notification message that carries a device identifier;
a confirming module, configured to confirm that a reset event corresponding to the reset notification message occurs on a peer device identified by the device identifier; and
a processing module, configured to delete an associated context related to the reset event.

17. The apparatus of claim 16, wherein the confirming module comprises:
a first request authenticating unit, configured to send an authentication request message that carries an authentication parameter to the peer device;
a first response authenticating unit, configured to receive an authentication response message that the peer device returns according to the authentication request, wherein the authentication response message carries information of the authentication parameter; and
a first confirming unit, configured to confirm that the reset event occurs on the peer device according to the information of the authentication parameter.

18. The apparatus of claim 16, wherein the confirming module comprises:
a second request authenticating unit, configured to send an authentication request message to the peer device;
a second response authenticating unit, configured to receive an authentication response message that the peer device returns according to the authentication request message, wherein the authentication response message carries information of an authentication parameter; and
a second confirming unit, configured to confirm that the reset event occurs on the peer device according to the information of the authentication parameter.

19. The apparatus of claim 16, wherein the reset notification message received by the receiving module comprises information of an authentication parameter, and the confirming module is configured to confirm that the reset event occurs on the peer device according to the information of the authentication parameter.

20. A system for processing session context, comprising a peer device and a local device, wherein:
the peer device is configured to send a reset notification message that carries a device identifier to the local device after a reset event occurs; and
the local device is configured to: receive the reset notification message that carries the device identifier, confirm that the reset event corresponding to the reset notification message occurs on the peer device identified by the device identifier, and delete an associated context related to the reset event.
